(19) United States
(12) Patent Application Publication
(10) Pub. No.: US 2026/0225572 A1
(43) Pub. Date: Aug. 6, 2026

(54) ELECTRIC BRAKE CARTRIDGE

(71) Applicant: Ausco Products, Inc., Benton Harbor, MI (US)

(72) Inventors: Shaun Bell, Benton Harbor, MI (US); Donald Schmidt, Benton Harbor, MI (US); Evan Whitney, Buchanan, MI (US); Peter Pozivilko, St. Joseph, MI (US); Edward Chandler, St. Joseph, MI (US); Keith McAllister, Kalamazoo, MI (US)

(21) Appl. No.: 19/530,878

(22) Filed: Feb. 5, 2026

Related U.S. Application Data
(60) Provisional application No. 63/754,833, filed on Feb. 6, 2025.

(51) Int. Cl. B60T 13/74; F16D 55/226; F16D 65/18; F16D 121/24; F16D 125/40; F16D 125/56

(52) U.S. Cl. CPC B60T 13/746; F16D 65/18; F16D 55/226; F16D 2121/24; F16D 2125/40; F16D 2125/56; F16D 2250/0084

(57) ABSTRACT

A cartridge for an electric brake includes a motor assembly including a spline as an output, with the spline being coupled with a spline of an actuator shaft. The actuator shaft includes an extension with male threading threaded with an inner female threading of a piston. An end plate is positioned around a portion of the actuator shaft and positioned between a flange of the motor assembly and a housing, the housing carrying the piston therewithin. The housing includes a threaded end adapted to fit a corresponding threading of a corresponding brake housing in order to attach the cartridge with the corresponding brake housing. Corresponding methods of installation and operation are also provided.

### CROSS REFERENCE TO RELATED APPLICATIONS

This application claims the benefit of U.S. Provisional Application No. 63/754,833, filed Feb. 6, 2025, which is incorporated herein by reference.

### TECHNICAL FIELD

One or more embodiments of this invention relate to a cartridge for an electric brake, such as an electric parking brake.

### BACKGROUND

Parking brakes can include adding a parking mechanism to a rear hydraulic caliper brake. Such conventional parking features have included a mechanical device added to a hydraulic caliper, which mechanical device is actuated by a steel cable connected to a foot pedal or hand lever. While this can be a suitable solution, the cost, space, assembly time, adjustment time, and weight of the cable with the pedal and lever assembly can be disadvantageous. Moreover, these parking cable assemblies can become somewhat impeded or made inoperable by corrosion, especially if the parking brake goes unused for long periods of time. Also, the mounting, adjusting, and repairing of the components requires considerable mechanical skill.

To solve these issues with parking cable assemblies, electric parking brakes have also become conventional. Instead of a hand lever or foot pedal taking up space, a simple switch can be used. And instead of a steel cable, a relay can carry a signal to engage or release the brake. Both the switch and the relay wire save on cost, assembly time, adjustment time, weight, and space. These electric parking brakes can also improve function, since the brake can be automatically activated by a controller (CPU) of the vehicle in certain circumstances, such as based on proximity sensors or a door being opened.

A common implementation for an automotive electric parking is to add an electric actuator to a hydraulic caliper brake. This can include an electric motor acting over a mechanical advantage, such as belt drives or gear drives, to turn a screw mechanism. The screw mechanism is a male screw engaged with a female thread inside a plunger. The plunger is prevented from rotation but is allowed to slide axially, so that as the screw turns, the plunger moves axially. The plunger pushes on the hydraulic caliper piston to engage the brake. Because of the mechanical advantage, a smaller motor with lower torque at high speed can be used to generate high forces. The screw pushing on the piston makes for a generally compact design operating at lower amperage with a smaller wire to carry the current.

The CPU of the vehicle directs control of brake actuation. When the operator or vehicle logic commands the brake to engage, the CPU signals a relay to apply current to the motor, causing the motor to turn. The motor will spin the screw to take up running clearance and then apply increasing motor torque until a desired output force at the screw is obtained. When the brake is released, the mechanism is reversed to draw the screw back a fixed distance. This control provides self-adjustment of the parking brake.

With a fixed distance of travel reset for every brake engagement, the time to engage the parking brake does not change with wear throughout the life of the brake; the screw always travels the same distance to engage the brake. As reference, while certain conventional cable operated parking brakes can be self-adjusting and accomplish the same function, they achieve self-adjustment mechanically. Conventional electric parking brake achieve the self-adjustment via software.

Because of the self-adjustment, a ‘service mode’ should be made available on these designs. As the brake wears, the plunger (and piston) travel farther and farther out of the bore to maintain the desired running clearance. Once the brake pads are worn out and ready for replacement, the piston and plunger need to be returned all the way back into the bore to accommodate the new brake pads, which will be thicker. The piston and plunger have pushed out of the bore a distance equal to the wear, and there is insufficient space for the new brake pads. In order to change the thinner, worn-out brake pads with thicker new ones, the plunger needs to be returned to the ‘new condition’ position for a ‘new condition’ brake pad. This is conventionally accomplished either by the vehicle CPU having a built-in function, or by a code reader/service tool that a mechanic uses to communicate with the CPU. Either way, the CPU will reverse the screw to pull the plunger all the way back into the bore for service. This is a necessary feature for this type of brake.

An exemplary conventional electric parking brake utilizes a custom two-piece housing with an electric motor actuator mechanism added to the two-piece housing. There is no piston or other hydraulic element, as a plunger simply pushes on the back of a stator plate to engage the brake. For this brake, the length of any particular caliper housing opposite the electric actuator is believed to be machined to different lengths to achieve allowances for different rotor thicknesses. Other custom features are believed to be necessary for this conventional brake, such as the need to make custom housings and stators. While this brake offers some flexibility for installation, it is believed to be somewhat limited to switching between lefthand and righthand orientations. This brake is also believed to require new mounting bracket tooling to accommodate different mounting configurations.

There remains a need in the art for an improved electric brake cartridge, especially a cartridge providing for flexibility in rotor size, motor orientation, and mounting bracket configuration.

### DISCLOSURE OF THE INVENTION

An object of one aspect of the present invention is a cartridge for an electric brake which can be utilized with a wide range of rotor diameters and thicknesses.

An object of another aspect of the present invention is a brake cartridge which does not require new housing and stator tooling for different vehicle variations.

An object of an additional aspect of the present invention is a brake cartridge which allows for flexible motor actuator orientations.

An object of a further aspect of the present invention is a brake cartridge which allows for flexible mounting bracket designs.

These and other objects of the present invention, as well as the advantages thereof over existing prior art forms, which will become apparent from the description to follow, are accomplished by the improvements hereinafter described and claimed.

In general, a cartridge for an electric brake includes a motor assembly including a spline as an output, the spline being coupled with a spline of an actuator shaft; the actuator shaft including an extension with male threading threaded with an inner female threading of a piston; an end plate positioned around a portion of the actuator shaft and positioned between a flange of the motor assembly and a housing, the housing carrying the piston therewithin; and the housing having a threaded end adapted to fit a corresponding threading of a corresponding brake housing in order to attach the cartridge with the corresponding brake housing.

In accordance with another aspect of the invention, a method of attaching a cartridge to a brake housing includes steps of machining a threaded bore into a brake housing; providing a cartridge including a threaded end and an electrically activated actuator shaft; and threading the threaded end of the cartridge into the threaded bore of the brake housing to thereby allow the electrically activated actuator shaft to act on a brake component of the brake housing.

In accordance with a further aspect of the invention, a method of positioning a brake includes steps of providing a brake including a motor assembly including a spline as an output, the spline of the motor assembly being coupled with a spline of an actuator shaft, the actuator shaft including an extension with male threading threaded with an inner female threading of a piston, the piston including a bore with a compression spring at the bottom thereof; calibrating the piston relative to the actuator shaft based on current of the motor assembly when the motor assembly is retracting the piston, where the step of calibrating defines a calibrated position for the piston; activating, after the step of calibrating, the motor assembly to retract the piston, such that the compression spring is gradually depressed; and deactivating the motor assembly when the piston is determined to be in the calibrated position.

### BRIEF DESCRIPTION OF THE DRAWINGS

FIG. 1 is a top view of a cartridge for an electric brake, shown coupled with a caliper housing as an assembly.

FIG. 2 is a front elevational view of the assembly of FIG. 1.

FIG. 3 is a sectional view taken substantially along line A-A of FIG. 2.

FIG. 4 is a side view of the cartridge and caliper housing assembly of FIG. 1.

FIG. 5 is a front elevational view of the cartridge of FIG. 1, shown separate from a housing.

FIG. 6 is a sectional view taken substantially along line B-B of FIG. 5.

FIG. 7 is a perspective view of an end plate of the cartridge of FIG. 5.

FIG. 8 is a perspective view of the cartridge of FIG. 5.

FIG. 9 is a perspective view of the assembly of FIG. 1.

FIG. 10 is a perspective view of the caliper housing of FIG. 1.

FIG. 11 is a perspective view of a caliper housing casting utilized to form the caliper housing of FIG. 1.

FIG. 12 is a perspective view of the assembly of FIG. 1, though shown with an alternative end plate and an alternative location for a set screw.

FIG. 13 is a perspective view of the alternative end plate of the assembly of FIG. 12.

FIG. 14 is a perspective view of the assembly of FIG. 12, though shown with an alternative caliper housing and with a relatively long set screw.

### DETAILED DESCRIPTION

One or more embodiments of the present invention relate to a cartridge for an electric brake, such as an electric parking brake or an electric service brake. Advantageously, the cartridge of embodiments of the present invention allows for flexibility in rotor size, motor orientation, and mounting bracket configuration, as will be further discussed herein. The corresponding brake with which the cartridge can be utilized can be any suitable mechanical brake design. Exemplary mechanical brakes include caliper brakes, multi-disc ball ramp brakes, mechanical drum brakes, and cam brakes.

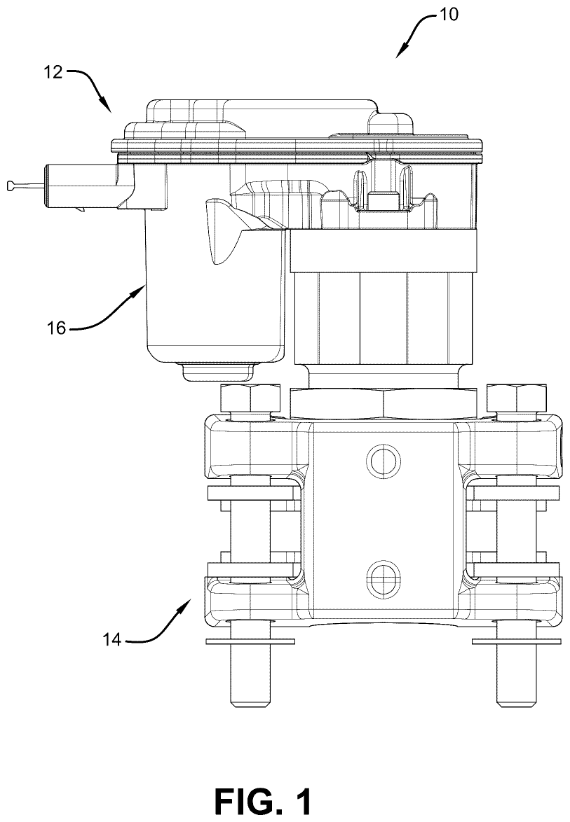

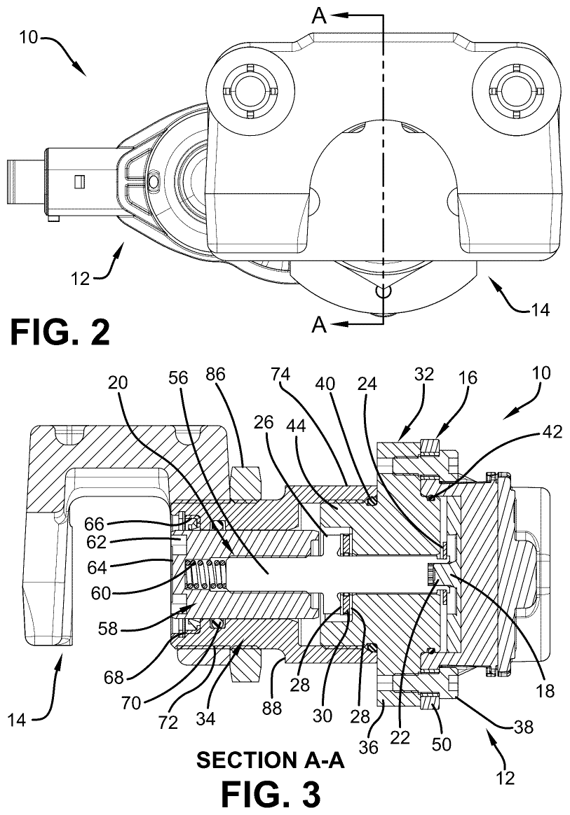

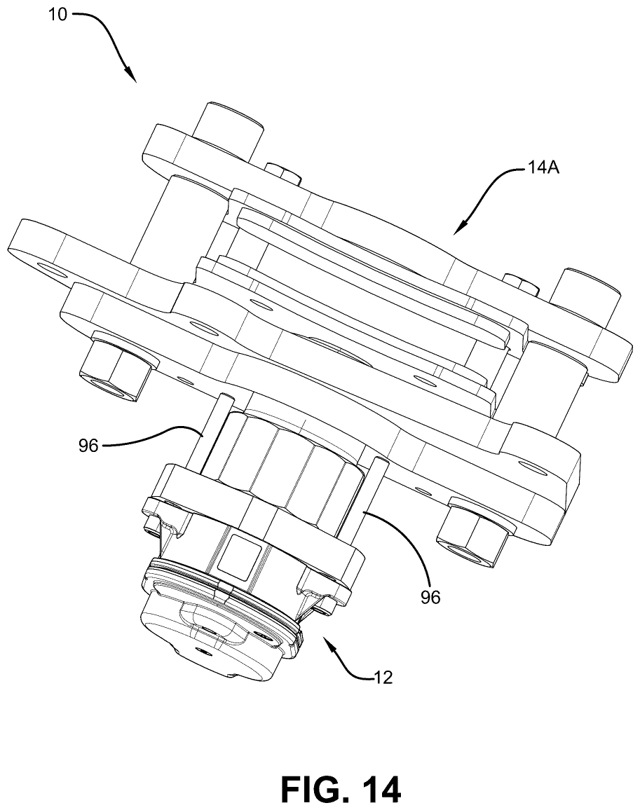

With reference to the Figures (FIGS. 1 to 14), an assembly according to one or more embodiments of the present invention is generally indicated by the numeral 10. The assembly 10 includes a cartridge 12, which may also be referred to as an electric brake cartridge 12, a cartridge assembly 12, or an electric park brake component 12, attached to a caliper brake, which may also be referred to as a caliper housing, for use therewith. A first particular caliper housing 14 is shown in FIGS. 1 to 12, and a second particular caliper housing 14A is shown in FIG. 14. While the particular caliper housings 14, 14A are shown and described, it should be appreciated that cartridge 12 can be adapted to be utilized with a variety of caliper housings and other suitable types of mechanical brakes. Generally speaking, as long as there is adequate material for the brake housing to receive a threaded surface of cartridge 12 for attachment thereof, any suitable housing can be used with cartridge 12. As should be appreciated from the description which follows, the design of cartridge 12 allows for changing the machining on various housings in order to accommodate attachment with cartridge 12. Said another way, cartridge 12 can be used with existing mounting brackets and stator plates without a need for new or custom tooling.

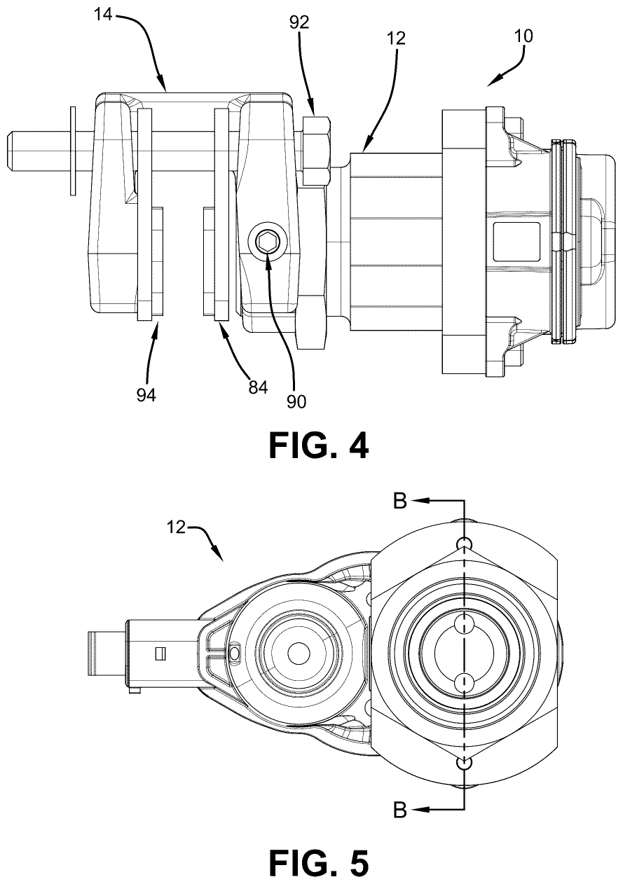

Cartridge 12 includes an electric motor 16, which may also be referred to as motor 16 or motor assembly 16. The motor 16 shown in the Figures is a conventional commercially available motor, which is available from Oeschler. Other similar motors from other manufacturers will also be suitable. While certain details relative to motor 16 are disclosed herein, other details will be generally known to the skilled person. Motor assembly 16 includes an electric actuator including a motor with a gear reduction (not seen). The gear reduction is used to amplify torque, allowing a relatively small and high-speed electric motor to create a much higher output torque at lower speed. The output from electric motor 16 is a small male spline 18 which interacts with an actuator shaft 20 (FIG. 3). The output male spline 18 from electric motor 16 couples at the right hand end of actuator shaft 20. Particularly, actuator shaft 20 has a female spline 22 that accepts the male spline 18 from electric motor 16, such that actuator shaft 20 may be referred to as being electrically activated. A retaining ring 24 holds actuator shaft 20 onto the output spline 18 of motor 16 and prevents them from decoupling. While motor 16 is shown with male spline 18, other motors may utilize a female spline as the motor output, in which case the actuator shaft 20 can be provided with a male spline for coupling with the female spline of the motor, with other details corresponding to the description above and herein.

Actuator shaft 20 can be formed from carbon or other alloy steel and can be heat treated for wear resistance. Actuator shaft 20 can also have a gas or salt bath nitride layer for corrosion resistance. Actuator shaft 20 includes a flange 26 formed about midway between the motor side and the brake side of actuator shaft 20. The flange 26 rests on a combination of a pair of thrust washers 28 and needle thrust bearing 30. Needle thrust bearing 30 is trapped between thrust washers 28 as a needle thrust bearing assembly, which allows the rollers of needle thrust bearing 30 to roll on the hardened surfaces of thrust washers 28. In absence of the hardened surfaces, the rollers of needle thrust bearing 30 can otherwise wear and damage the mating parts. Other bearing materials will also be suitable in place of the combination of thrust washers 28 and needle thrust bearing 30, such as a metal (e.g., bronze) bushing or a plastic bearing made of a suitable plastic material.

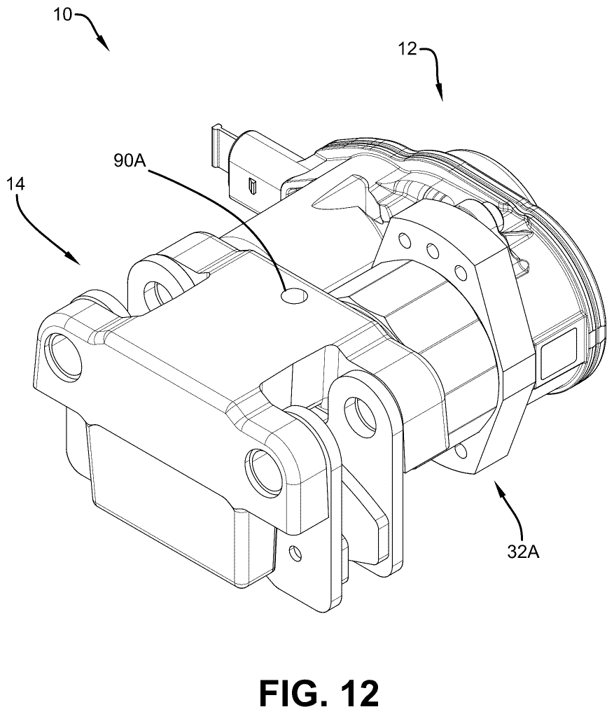

An end plate is sandwiched between motor assembly 16 and a housing 34 by particular way of a pair of radial outward extensions 36, which are shown as being diametrically opposed. That is, respective faces or ends of radial outward extensions 36 contact motor assembly 16 and housing 34. A first particular end plate 32 is shown in FIGS. 3 to 9 and a second particular end plate 32A is shown in FIGS. 12 to 14. Except for as otherwise disclosed herein, it should be appreciated that description relative to end plate 32 also applies to end plate 32A. End plate 32 is secured with motor 16 via a plurality of fasteners 38, which can be screws such as socket head cap screws. Alternative suitable motor assemblies may have different mounting needs, such as including different numbers of attachment locations. Said another way, different numbers of extensions 36 and fasteners 38 (e.g., three, four, or other suitable number) may be utilized for different motors.

At least a portion of the spline (e.g., female spline 22) of actuator shaft 20 and at least a portion of the spline (e.g., male spline 18) of electric motor 16 are positioned within a main body portion of end plate 32. End plate 32 serves as a reaction surface for washers 28 and needle thrust bearing 30. That is, the combination of the thrust washers 28 and the needle thrust bearing 30 are positioned between the flange 26 and an inner portion of the end plate 32. End plate 32 can be formed from aluminum and may be made by machining a raw billet, though other processes are possible. End plate 32 can be anodized or hard coat anodized. Housing 34 can also be made from aluminum and may be formed from an extrusion process and then machined, though other methods are possible. Housing 34 may also be anodized or hard coat anodized.

End plate 32 can be used in conjunction with an O-ring 40 and a second O-ring 42. O-ring 40 seals end plate 32 to housing 34, thereby preventing water and/or dirt intrusion. O-ring 42 seals end plate 32 to motor 16, thereby preventing water and/or dirt intrusion and corresponding damage to the motor.

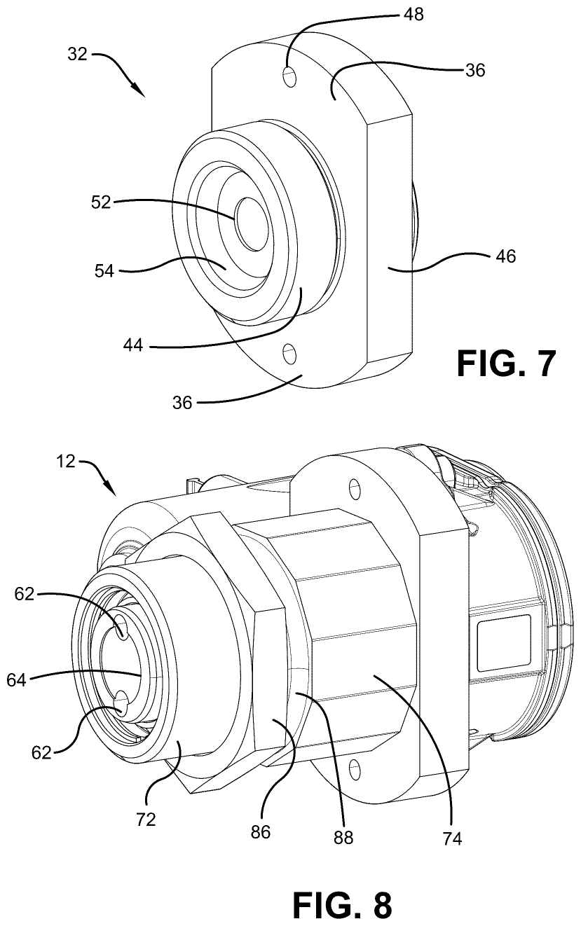

End plate 32 has an extension 44 facing the brake side, which extension 44 is generally shaped as a cylindrical shell. Extension 44 can have a male thread on the outer surface thereof, as best seen in FIG. 7. The male thread is used to thread extension 44 into a mating female thread within housing 34. Where both end plate 32 and housing 34 are formed from a relatively soft metal material (e.g., aluminum), it is believed that the threads will distort somewhat when the two components are torqued together. Given a relatively large diameter of the threads and the anticipated thread distortion when assembled, the threads should self-lock and are unlikely to vibrate apart in service.

The sides of end plate 32 include flat surfaces 46, which are intended to allow a tool, such as an adjustable wrench, to rotate end plate 32 for threaded assembly. End plate 32 includes a through hole 48 within each of the radial outward extensions 36, which through holes 48 can be generally centrally located relative to a width of end plate 32 and can be diametrically opposed with each other. Through holes 48 can be threaded and are intended to allow socket head cap screws 38 to bolt through a flange 50 (FIG. 3) of motor 16 to assemble motor 16 to end plate 32. Plain holes could be utilized in place of the threaded holes, along with a self-tapping screw in place of socket head cap screws 38. A through hole 52 (FIG. 7) is machined into end plate 32 to accept actuator shaft 20. A counterbore 54 (FIG. 7) is formed in end plate 32 to accept flange 26 and the needle thrust bearing assembly described above.

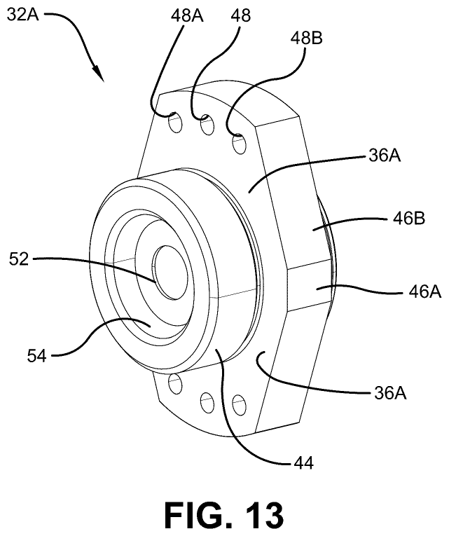

With reference to FIGS. 12 to 14, differences between end plate 32 and end plate 32A are now described. First, the two radial outward extensions 36A of end plate 32A are shaped different than extensions 36. This is based on flat surfaces 46A being relatively smaller than flat surfaces 46 and extending to angled surfaces 46B. Also, end plate 32 is shown with a single through hole 48 within each of the radial outward extensions 36, whereas end plate 32A further includes additional through holes 48A, 48B (FIG. 13) at each side of generally central through hole 48 within each of radial outward extensions 36A. Through holes 48, 48A, 48B can be threaded and can be diametrically opposed with respective ones in the other radial outward extension 36A. As a first function, holes 48, 48A, 48B allow socket head cap screws 38 to bolt through a flange 50 of motor 16 to assemble motor 16 to end plate 32A. The additional through holes 48A, 48B provide additional orientations for attaching motor 16. That is, end plate 32A provides three angular orientations for a right hand motor attachment and three more orientations for a left hand motor attachment. This provides additional flexibility for mounting cartridge 12 relative to a corresponding vehicle (not shown).

A second function of the additional through holes 48A, 48B is for receiving a relatively longer set screw 96 (FIG. 14) as a locking mechanism for orientation of cartridge 12. One of the holes 48, 48A, 48B will receive fastener 38 and one of the other holes 48, 48A, 48B can receive relatively longer set screw 96. As shown in FIG. 14, this can include one relatively longer set screw 96 being positioned within each of radial outward extensions 36A. In other embodiments, only one of the radial outward extensions 36A includes relatively longer set screw 96. The relatively longer set screw 96 will be threaded into one of the holes 48, 48A, 48B until an end of the relatively longer set screw 96 contacts brake housing 14A. Of note, the term ‘relatively longer’ is based on set screw 96 being longer relative to its diameter in order to provide the locking function as now described. Once the relatively longer set screw 96 contacts the brake housing 14A, the relatively longer set screw 96 is torqued down. The end or tip of relatively longer set screw 96 can be made as a cup shape, though other shapes (e.g., conical or flat) can be suitable. Since set screw 96 is torqued down, set screw 96 deflects in compression. As is generally known to the skilled person, when trying to keep a threaded member (e.g., bolt) tight, it can be preferable to stretch the threaded member. The length of the threaded member (i.e., set screw 96) being stretched is typically known as grip length. When the threaded member stretches, the threaded member becomes resistant to vibration and has less tendency to come loose. The grip length can be about or at least four diameters long to ensure that the threaded member (i.e., set screw 96) does not tend to shake loose. Even higher length to diameter ratios can be utilized for additional stretch and resistance to vibration. Here, the function of set screw 96 is similar, except instead of stretching set screw 96, set screw 96 is compressed. Set screw 96 has a grip length of well greater than the four to one ratio described above. The amount of deflection for set screw 96 is the same in compression as it would be if experienced in tension. With a relatively high force between the tip or end of set screw 96 and brake housing 14A, and a suitable amount of deflection ensuring set screw 96 does not come loose, the friction created by the interface of set screw 96 and housing 14A is effective at locking down rotation in any orientation selected. While a set screw 96 is disclosed and described, other screw devices are possible, such as a small hex bolt or a socket head screw.

Turning back to actuator shaft 20, actuator shaft 20 has an extension 56 extending away from flange 26, and therefore also away from motor 16 (i.e., on the left-hand end of actuator shaft 20 in the view of FIG. 3), which extension 56 acts as a male screw threading relative to an inner female threading of a piston 58. Said another way, piston 58, which may also be referred to as a plunger 58, contains an inner female thread that mates to the threaded extension 56 of actuator shaft 20, which threaded extension 56 may also be referred to as threaded end 56. The threaded extension 56 begins at about an end of end plate 32 and extends into the inner female thread of piston 58. Piston 58 can be made from stainless steel for corrosion resistance and may be heat treated for wear resistance, though plain carbon or other alloy steels with plating or nitriding for corrosion resistance are suitable. A compression spring 60 is placed at the bottom of the bore in piston 58 and is compressed between piston 58 and actuator shaft 20, and the function thereof will be further described herein.

At the brake end of piston 58, piston 58 includes two axial, diametrically opposed counterbores 62. Counterbores 62 (FIG. 3 and FIG. 8) are intended to accept a commercially available brake piston tool commonly used with self-adjusting automotive caliper brakes, or other similar spanner wrenches. The tool can be used to turn the piston 58 or prevent rotation of the piston 58 during assembly. The brake end of piston 58 also includes a shallow counterbore 64 machined into the axial end, and the function thereof will be further described herein.

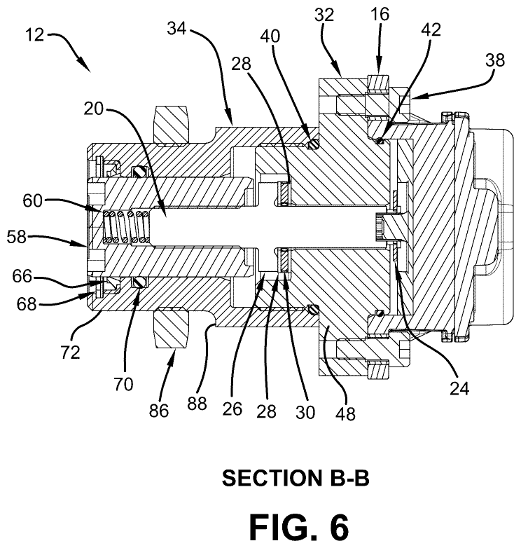

As best seen in FIG. 3 and FIG. 6, piston 58 is carried by the housing 34. A seal 66 is placed in a counterbore in housing 34 to prevent water and dirt intrusion between piston 58 and housing 34. A retaining ring 68 is inserted into an adjacent groove in housing 34 to assist with positive retention of seal 66 in the counterbore in housing 34. A rather large cross section O-ring 70 is placed in a groove in housing 34. O-ring 70 does not serve as a seal but is instead meant to create friction to prevent rotation, as will be further discussed. It may also be possible to use friction from seal 66 without the need for O-ring 70.

Housing 34 has a large diameter thread on an external surface 72 near the end of housing 34. This threading can be the same size as the threaded joint between end plate 32 and housing 34 described above, which allows for common tooling. Other threading sizes are also suitable.

At the other end of housing 34, housing 34 includes an external flat surface portion 74. The term flat surface portion is intended to mean that at least portions of the external surface are flat, not that the entire surface is flat. That is, flat surface 74 is shown with a dodecagon shaped perimeter. The dodecagon shaped perimeter, or other shape with flat surfaces, can be used to rotate housing 34 for assembly of the large thread surface 72 into a mating portion 76 (FIG. 10) of a corresponding housing (i.e., caliper housings 14, 14A). Other suitable shapes for the flat surface 74 include other polygons (e.g., decagons, hexagons, octagons), and two flat surfaces between two rounded surfaces (i.e., similar to surfaces 46). The use of shapes with a relatively greater number of flat surfaces (e.g., dodecagon) provide additional surfaces in many directions to accommodate a tool, such as an adjustable wrench.

As mentioned above, the cartridge 12 is envisioned for use with an electric brake, such as an electric parking brake or an electric service brake. This is represented in the Figures via caliper housings 14, 14A. The assembly 10 of cartridge 12 with one of the caliper housings 14, 14A may be referred to as an electric caliper park brake 10. The external threaded surface 72 assembles cartridge 12 with mating portion 76 (FIG. 10) of one of the caliper housings 14, 14A, which mating portion 76 may also be referred to as threaded bore 76. Threaded bore 76 accepts the external threading from surface 72.

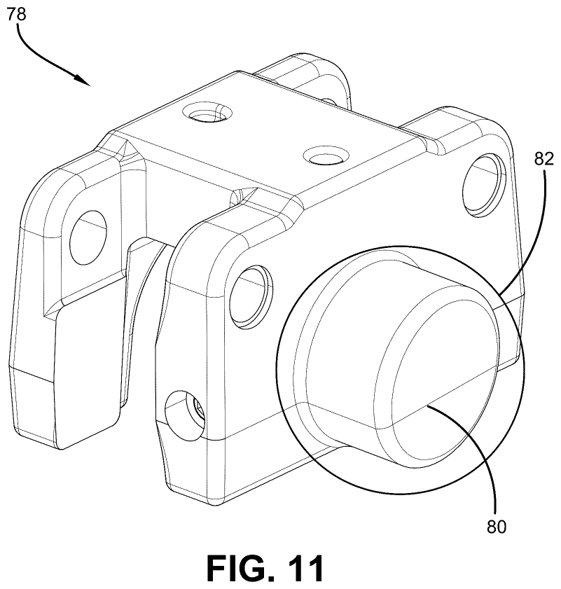

Certain description of housing 14 is now provided and it should be appreciated that this can also extend to housing 14A. Housing 14 can be machined from a part 78 used to manufacture a small hydraulic caliper. This part 78, which may be referred to as an initially machined housing casting 78, is shown in FIG. 11, which has been somewhat machined from a raw casting. Housing casting 78 has a cylindrical projection 80 sticking out. As shown in FIG. 11, this casting is machined for its conventional use. In order to achieve housing 14 for embodiments of the present invention, the cylinder portion 80 can be cut off by machining, and the casting can be bored out and threaded to accept the cartridge 12 as shown in FIG. 10. This step of forming an existing housing into a housing 14 for use with cartridge 12 is represented by the circle numbered 82 in FIG. 11.

It should also be appreciated that housings 14, 14A can be achieved by selective machining of similar raw parts that are not castings, such as laser cut steel plates, powdered metal, or other processes.

Since the casting 78 for housing 14 has sufficient material to accommodate the formation of threaded bore 76 for receiving external threaded surface 72 of cartridge 12, casting 78 can be adapted to accept the cartridge 12 without new tooling. This would include simply a different machining of the same part 78 from an existing tool. This same function can be extended for any existing housing (e.g., caliper housing 78). If the existing housing can be machined to accept the external threaded surface 72 of cartridge 12, then the existing housing can be adapted to become electrically actuated. This would be true for existing tooling on both mechanical and hydraulic brakes.

Since only the existing housing (e.g., caliper housing 78) has been modified, everything else in the existing brake corresponding to the existing housing remains useful. For example, the mounting bolts, the lined stators, and the mounting bracket would be unchanged. Moreover, if the new brake (e.g., assembly 10) can be made to fit the package envelope, the new brake is fully compatible with existing brake installations. The mounting would be the same, and the new brake would be designed for the same width and diameter rotor using the same stator plates, all without new tooling of the housing, mounting bracket, or stator plates.

The design for any particular configuration of cartridge 12 can take into account motor orientation and mounting bracket design. Bracket design is often not just a flat plate and may include bends and offsets, bushings, and possibly seals depending on the application. Another consideration is where the brake is positioned on the vehicle. The parking brake may be at the wheel, or it may be placed somewhere in the driveline (e.g., at the input to the differential), on the transmission, or another position. The fit-up requirements can depend on the location and what package envelope is available.

The threaded end 72 of housing 34 generally allows for the flexibility of the various applications for cartridge 12. The threaded end 72 can be adapted to fit different housings (e.g., housings 14, 14A). Moreover, if the thread 72 does not need to be locked down in a particular axial or rotational position, then even further flexibility is achieved. The cartridge 12 can be moved in or out axially to whatever distance is needed by a particular housing to engage piston 58 appropriately with a stator plate 84 (FIG. 4). Moreover, motor 16 can be oriented in a countless number of rotational positions. In this way, it would be preferred if the threads 72 of housing 34 are not required to be set in any particular position but can be locked down wherever they are required.

Once motor 16 is turned into the desired or ideal location for motor orientation, the threads of threaded end 72 and corresponding threads of the brake housing (e.g., threaded bore 76) should be locked to prevent motion. Said another way, the motor should be locked into a desired or ideal axial position and a desired or ideal rotational position. A number of main embodiments are disclosed here for this function. A first main embodiment for the locking function is the relatively longer set screw 96 as disclosed above.

In a second main embodiment for the locking function, a hex nut 86 can be positioned around a portion of the threaded end 72 of the housing 34 such that hex nut 86 can be turned to contact the brake housing (e.g., caliper housings 14, 14A), as generally shown in FIG. 3, which may also be referred to as being turned against the brake housing. This creates friction and prevents movement of the threaded end 72 and corresponding threads of the brake housing (e.g., threaded bore 76).

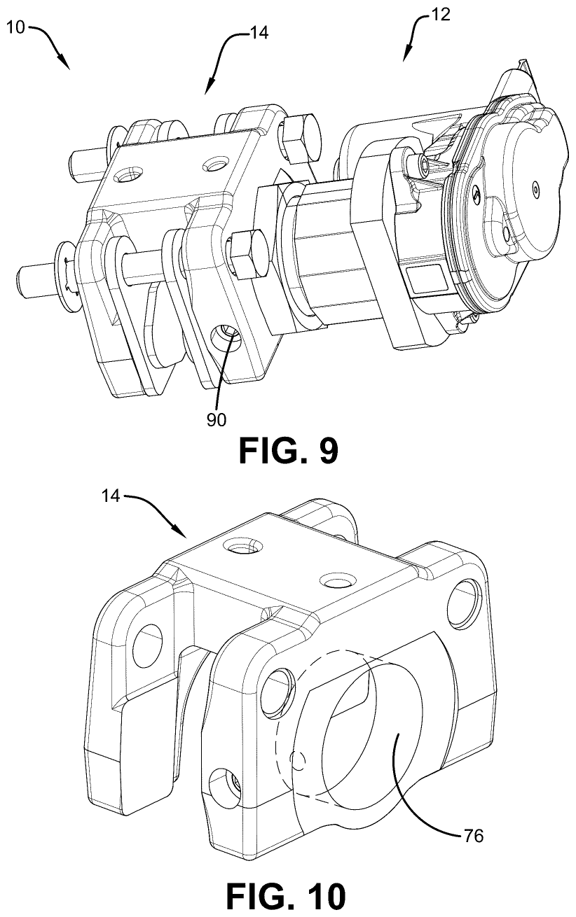

In a third main embodiment for the locking function, a set screw 90 (FIG. 9) can be placed in the brake housing (e.g., caliper housings 14, 14A). The set screw 90 can push a deformable element (e.g., plastic, brass, aluminum) into the threaded end 72 of housing 34 to prevent rotation. However, not all brake housings may have material and space available for the set screw 90. Where utilized, set screw 90 can be radially positionable in various locations. As shown in FIGS. 4, 9, and 10, set screw 90 can be radially positioned on a relative side of housing 14, which may be referred to as a generally 9 o'clock position. As shown in FIG. 12, in other embodiments, a set screw 90A can be radially positioned on a relative top of housing 14, which may be referred to as a generally 12 o'clock position. The set screw can also be radially positioned in other angular orientations, and the particular orientation can be selected based on the shape of a particular caliper housing 14, 14A, machining details, and/or assembly details.

The braking function of cartridge 12 will now be described. The cartridge 12 is shown in the Figures in the released position. Piston 58 is moved to right, such that piston 58 is not in contact with a mating stator plate 84 (FIG. 4), placed on the left side of piston 58 in the configuration of the Figures.

When activated, motor 16 rotates actuator shaft 20 against compression spring 60, but it should be recognized that when actuator shaft 20 is not in contact with mating stator 84, and there is running clearance in the released position, there is no load on the mechanism. In effect, it is free spinning, albeit there is some small friction between the mating threads of piston 58 and actuator shaft 20, which friction would be trying to urge piston 58 to rotate. This friction can be reduced by greasing the threads prior to assembly. The thread friction acts at the radius of the thread. Therefore, a small, lubricated friction load will be acting at a small radius creating a small torque urging piston 58 to rotate. This small torque needs to be resisted, or actuator shaft 20 and piston 58 would rotate together.

There is friction between O-ring 70 and piston 58 due to the squeeze on O-ring 70. By controlling the diameter of the O-ring groove in housing 34, and the outside diameter of piston 58, the squeeze on O-ring 70 can be controlled. The friction between O-ring 70 and piston 58 is directly related to this squeeze, and this friction can be purposely made considerably larger than the lubricated friction between the threaded components while in the free running condition.

The friction due to the squeeze of O-ring 70 acts at the outside diameter of piston 58, the radius of which is about 2.4 times the radius of the threaded components. Since the squeeze of O-ring 70 on the outside diameter of piston 58 results in a larger friction force and much larger radius, the torque due to friction on the outside diameter of piston 58 is much larger than the torque due to lubricated friction on the threads acting at a much smaller distance. Thus, friction from O-ring 70 acting on piston 58 impedes rotation of piston 58 while the mechanism is free spinning to take up running clearance. Since piston 58 cannot spin when there is running clearance in the brake, piston 58 is urged to move left (relative to the configuration of the Figures) until piston 58 contacts the mating stator plate 84.

As will be recognized by one skilled in the art, pushing the stator plate 84 into contact with a rotating disc (not shown) will cause a floating mount caliper brake to slide on the mount 92 (FIG. 4) to bring a carrier side stator 94 into contact with the opposite side of the rotor. Once all running clearance is taken up on both sides of the rotor, motor 16 starts to load down, which creates increasing torque on actuator shaft 20. This in turn creates higher output forces on piston 58 and thus on the stators 84, 94. The force on the stators 84, 94 creates a braking effect on the brake rotor. In one or more embodiments, cartridge 12 can achieve a clamping force of up to about 7,500 lbs. clamping. In one or more embodiments, cartridge 12 can achieve a clamping force of up to about 10,000 lbs. clamping. Other clamping forces can be utilized.

Since the torque output of motor 16 is directly related to the current applied to the motor, the CPU (not shown) can control the force that cartridge 12 applies to stators 84, 94. If, for instance, assembly 10 is a parking brake, the CPU can apply a known amperage to the motor to achieve a known clamping force on stators 84, 94, thus controlling parking torque capacity.

As the torque from motor 16 acting on actuator shaft 20 goes up, the force from piston 58 pushing on the stator 84 goes up in a linear relationship. This causes the friction between the threaded members of actuator shaft 20 and piston 58 to likewise go up in a linear fashion resulting in relatively high friction on the threaded joint. This will then no longer be a free spinning mechanism and will be under increasingly high torque load due to friction urging piston 58 to rotate. These higher torque loads must be resisted, or piston 58 will rotate with actuator shaft 20.

The friction created by O-ring 70 does not increase with increased torque load on the threads. This friction is a constant since it is dependent upon the squeeze of the O-ring 70. Thus, once running clearance is taken up and high loads are applied to the threads (i.e., not in a free running condition), another source for impeding rotation of piston 58 is needed. Without this, torque due to thread friction would rapidly overcome the torque due to friction of O-ring 70, and piston 58 would rotate.

The left side of piston 58 is now in contact with the stator 84, which is generally an unlubricated stainless steel piston surface acting on a plain carbon steel backing plate of the stator 84. The clamping force between piston 58 and the stator 84 creates considerably higher friction forces resisting rotation of piston 58 compared to the lubricated friction between the threads of stainless steel piston 58 and plain carbon steel actuator shaft 20.

As mentioned above, piston 58 includes shallow counterbore 64 seen at the left end of piston in FIG. 3. This counterbore 64 makes the mean contact radius between piston 58 and the stator plate 84 larger. The mean radius in the specific embodiment of the Figures is about 1.6 times the radius of contact on the screw threads. Thus, there is a larger unlubricated friction force acting on a larger radius between piston 58 and the stator 84, creating a relatively large torque to resist rotation of piston 58 due to the urging of friction between the respective threads of actuator shaft 20 and piston 58. Moreover, this friction is directly linear with respect to clamping forces. That is, as the clamping force goes up due to increased torque from motor 16, the resistance to rotation goes up proportionally, ensuring that piston 58 never rotates under load.

Since this large friction occurs on the face of piston 58, it does not contribute to axial drag on piston 58. If, for instance, a keyway was placed on the outside diameter of piston 58, the resistance to torque would create a large axial friction component, which would directly reduce the force available to push on the stator 84. This would reduce clamping force on the stator 84, resulting in lower mechanical efficiency and less braking effect. In the configuration of embodiments of the present invention, the loss of axial force due to friction is solely due to the friction of O-ring 70, and that force is relatively small and is constant regardless of clamping forces. The friction on the face of piston 58 resists rotation of piston 58 but contributes nothing to axial drag.

When the brake 14 is ready for release, a CPU (not shown) applies a reverse current to motor 16. The motor 16 turns actuator shaft 20 in reverse. Friction between O-ring 70 and piston 58 holds piston 58 stationary against rotation. Piston 58 now moves to the right, away from the stator plate 84, to release the brake 14. Piston 58 moves a set distance to create an ideal running clearance, which can be about 0.015″ in one or more embodiments of the present invention.

Aspects related to preventing a hard stop condition are now described. In the new, unworn condition of stators 84, 94, piston 58 needs to be moved into a new, unworn position. This would be true for initial assembly of cartridge 12 as well as during any service operation for cartridge 12, so that new unworn stators 84, 94 can be assembled. The CPU should be able to sense the new, unworn position without having the components hit a hard stop, which may cause damage to the mechanism. The CPU can detect a hit against a hard stop by measuring the reverse current to motor 16, since when the device hits the hard stop, current will rise rapidly, and the CPU can shut off the current. However, this should account for the undesired scenario where the sudden rise in current could be detected too late to prevent damage, since the mechanism is in motion and would be very suddenly stopped.

It should also be noted that cartridge 12 is designed to apply high forces against stators 84. When the force of piston 58 is pushing against stator 84, those high forces of piston 58 are reacted by the combination of needle thrust bearing 30 and washers 28 acting against end plate 32. However, when motor 16 is actuated in reverse to retract piston 58, actuator shaft 20 is no longer pushing against needle thrust bearing 30 and washers 28. This force is now pulling actuator shaft 20 away from motor 16, and the force is now reacted by retaining ring 24 pulling against end plate 32. When motor 16 is in reverse, forces should be low, because the retracting piston 58 only requires enough force to overcome the friction of O-ring 70 as previously described. However, since retaining ring 24 is formed from a relatively hard material, such as high carbon steel, and end plate 32 is intended to be formed from relatively soft material, such as aluminum, retaining ring 24 may gouge or otherwise damage end plate 32, if the forces are excessive. Thus, limiting the force during retraction of piston 58 is important. Otherwise, a sudden, hard stop condition would likely cause such excessive force, which would thereby cause undesirable damage.

To avoid damage from a hard stop condition, compression spring 60 is placed between piston 58 and actuator shaft 20. As piston 58 moves right (FIG. 3) to return to its new, unworn position, compression spring 60 is gradually depressed, and the load of compression spring 60 increases in a linear fashion. Since the force of compression spring 60 is dependent upon its length, the position of piston 58 relative to actuator shaft 20 can be determined by measuring that force. Since the retraction force of cartridge 12 is directly related to the reverse current applied to motor 16, the position of piston 58 relative to actuator shaft 20 can be calibrated against the current of motor 16 when motor 16 is retracting piston 58. The CPU can reverse the current to motor 16 to retract piston 58 and shut off current to motor 16 when the motor current indicates that piston 58 is in its calibrated position, which may be referred to as a new, unworn position corresponding to new, unworn stators. This shutting off of current to motor 16 reduces or avoids risk of having the mechanism be damaged by hitting a hard stop. This method of indicating the position of piston 58 generally removes any need for electronic proximity sensors or limit switches of any kind.

As further description of cartridge 12, the end application for cartridge 12 will generally be an off-highway vehicle. Exemplary end application vehicles include zero-turn mowers, golf carts, airport ground support equipment, backhoes, and roller compactors.

Though cartridge 12 is shown in use with a floating mount caliper brake, it would also be possible to use cartridge 12 with a fixed mount, dual opposed caliper design. This would generally require two motor actuators but would be suitable as long as the package fits the available envelope.

In one or more embodiments, cartridge 12 can be employed with a controller (CPU). Some such applications will include a CPU being built into the vehicle. Where applicable, a standalone CPU could be used to control the brake.

As mentioned above, cartridge 12 can be utilized with a variety of rotor sizes. In one or more embodiments, cartridge 12 can be utilized with rotors having diameters of from about 6 inches to about 36 inches. In one or more embodiments, for smaller applications, cartridge 12 can be utilized with rotors having diameters of from about 6 inches to about 7 inches. In one or more embodiments, for medium applications, cartridge 12 can be utilized with rotors having diameters of from about 12 inches to about 13 inches. In one or more embodiments, for larger applications, cartridge 12 can be utilized with rotors having diameters of from about 20 inches to about 36 inches.

It is thus evident that an electric brake cartridge constructed and operated as described herein accomplishes the objects of the present invention and otherwise substantially improves the art.

What is claimed is:

1. A cartridge for an electric brake, the cartridge comprising
a motor assembly including a spline as an output, the spline being coupled with a spline of an actuator shaft;
the actuator shaft including an extension with male threading threaded with an inner female threading of a piston;
an end plate positioned around a portion of the actuator shaft and positioned between a flange of the motor assembly and a housing, the housing carrying the piston therewithin; and
the housing having a threaded end adapted to fit a corresponding threading of a corresponding brake housing in order to attach the cartridge with the corresponding brake housing.

2. The cartridge of claim 1, the end plate including radial outward extensions with respective faces thereof contacting the flange of the motor assembly and the housing, the cartridge further comprising a plurality of fasteners securing the flange of the motor assembly to the radial outward extensions of the end plate.

3. The cartridge of claim 1, where the spline of the motor assembly is a male spline and the spline of the actuator shaft is a female spline, or where the spline of the motor assembly is a female spline and the spline of the actuator shaft is a male spline.

4. The cartridge of claim 1, the end plate including a cylindrical extension facing a brake side thereof, the cylindrical extension of the end plate including male threading mated with female threading within the housing.

5. The cartridge of claim 4, the actuator shaft including a flange positioned within an inner portion of the extension of the end plate, the extension of the actuator shaft extending from the flange and into the inner female threading of the piston, the flange resting on a combination of a needle thrust bearing and a pair of thrust washers, such that the end plate can serve as a reaction surface for the combination of the needle thrust bearing and the pair of thrust washers.

6. The cartridge of claim 2, the radial outward extensions including a respective threaded through hole for receiving a respective one of the plurality of fasteners, the threaded through holes being generally centrally located within the radial outward extensions relative to widths of the radial outward extensions.

7. The cartridge of claim 6, further comprising additional threaded through holes at each side of the generally centrally located through holes, the additional threaded through holes being adapted to receive a relatively longer set screw for locking the threaded end of the housing with the corresponding threading of the corresponding brake housing.

8. The cartridge of claim 1, at least a portion of the spline of the actuator shaft and at least a portion of the spline of the motor assembly being positioned within a main body portion of the end plate.

9. The cartridge of claim 1, further comprising a locking mechanism for locking the threaded end of the housing with the corresponding threading of the corresponding brake housing.

10. The cartridge of claim 9, the locking mechanism including a hex nut positioned around a portion of the threaded end of the housing, such that the hex nut can be turned against the corresponding brake housing.

11. The cartridge of claim 9, the locking mechanism including a set screw radially positioned in a side or a top of the corresponding brake housing, such that the set screw can push a deformable element into the threaded end of the housing to prevent rotation.

12. The cartridge of claim 1, the housing including an external flat surface portion with at least portions thereof being flat.

13. The cartridge of claim 12, where the external flat surface portion is a polygon shaped perimeter.

14. The cartridge of claim 1, the piston including a counterbore at a brake end thereof which serves to increase a mean contact radius between a piston and a respective stator plate of a corresponding brake.

15. The cartridge of claim 1, wherein the cartridge can be utilized with a rotor having a diameter of from about 6 inches to about 36 inches.

16. A method of attaching a cartridge to a brake housing, the method comprising steps of
machining a threaded bore into a brake housing;
providing a cartridge including a threaded end and an electrically activated actuator shaft; and
threading the threaded end of the cartridge into the threaded bore of the brake housing to thereby allow the electrically activated actuator shaft to act on a brake component of the brake housing.

17. The method of claim 16, wherein all existing brake components of a brake corresponding to the brake housing can be utilized, without new tooling, with the threaded end of the cartridge being threaded into the threaded bore of the brake housing.

18. A method of positioning a brake, the method comprising steps of
providing a brake including a motor assembly including a spline as an output, the spline of the motor assembly being coupled with a spline of an actuator shaft, the actuator shaft including an extension with male threading threaded with an inner female threading of a piston, the piston including a bore with a compression spring at the bottom thereof;
calibrating the piston relative to the actuator shaft based on current of the motor assembly when the motor assembly is retracting the piston, where the step of calibrating defines a calibrated position for the piston;
activating, after the step of calibrating, the motor assembly to retract the piston, such that the compression spring is gradually depressed; and
deactivating the motor assembly when the piston is determined to be in the calibrated position.

19. The method of claim 18, where the calibrated position for the piston corresponds to installation of a new, unworn set of stators.
